(19) United States
(12) Patent Application Publication
(10) Pub. No.: US 2026/0058589 A1
(43) Pub. Date: Feb. 26, 2026

(54) DRIVE DEVICE

(71) Applicant: TOYOTA JIDOSHA KABUSHIKI KAISHA, Toyota-shi (JP)

(72) Inventor: Shohei Oi, Okazaki-shi (JP)

(73) Assignee: TOYOTA JIDOSHA KABUSHIKI KAISHA, Toyota-shi (JP)

(21) Appl. No.: 19/175,094

(22) Filed: Apr. 10, 2025

(30) Foreign Application Priority Data
Aug. 20, 2024 (JP) 2024-139238

(51) Int. Cl. H02P 27/06; H02P 23/06; H02P 29/68

(52) U.S. Cl. CPC H02P 27/06; H02P 23/06; H02P 29/68

(57) ABSTRACT

A drive device includes: a power storage device; a motor including a three-phase coil; a first inverter that is connected to a power line to which the power storage device is connected and is also connected to a first end side of the three-phase coil, the first inverter including a plurality of first switching elements; a second inverter that is connected to the power line and is also connected to a second end side of the three-phase coil, the second inverter including a plurality of second switching elements; a cooling device configured to cool the power storage device, the motor, the first inverter, and the second inverter using a cooling medium; and a control device configured to control the first inverter and the second inverter based on a torque command of the motor. The control device is configured to control the first inverter and the second inverter.

### CROSS-REFERENCE TO RELATED APPLICATION

This application claims priority to Japanese Patent Application No. 2024-139238 filed on August 20, 2024. The disclosure of the above-identified application, including the specification, drawings, and claims, is incorporated by reference herein in its entirety.

### BACKGROUND

### 1. Technical Field

The present disclosure relates to a drive device.

### 2. Description of Related Art

In the related art, as a drive device of this type, a drive device including a motor (electric motor), an inverter, and a hydraulic pressure mechanism has been proposed (for example, see Japanese Unexamined Patent Application Publication No. 2009-44805 (JP 2009-44805 A)). The motor includes two rotors. The hydraulic pressure mechanism supplies the hydraulic oil to a phase change mechanism provided in a rotor of the motor. In the device, when the temperature of the hydraulic oil is lower than a predetermined temperature, the stator coil of the motor is energized to heat the hydraulic oil. As a result, the responsiveness of the phase change at the time of the low temperature is improved.

### SUMMARY

Incidentally, a drive device including a power storage device, a motor having a three-phase coil, and first and second inverters is also proposed. The first and second inverters are each connected to a power line to which the power storage device is connected. The first inverter is connected to a first end side of the three-phase coil and includes a plurality of first switching elements. The second inverter is connected to a second end side of the three-phase coil and includes a plurality of second switching elements. In the drive device in which the first and second inverters and the motor are H-connected as described above, it is recognized that it is an important issue to increase the amount of heat generated by the motor and the first and second inverters in order to heat the power storage device.

A main object of a drive device of the present disclosure is to increase the amount of heat generated.

In order to achieve the above-described main object, the drive device of the present disclosure adopts the following means.

A drive device of the present disclosure includes: a power storage device; a motor including a three-phase coil; a first inverter that is connected to a power line to which the power storage device is connected and is also connected to a first end side of the three-phase coil, the first inverter including a plurality of first switching elements; a second inverter that is connected to the power line and is also connected to a second end side of the three-phase coil, the second inverter including a plurality of second switching elements; a cooling device configured to cool the power storage device, the motor, the first inverter, and the second inverter using a cooling medium; and a control device configured to control the first inverter and the second inverter based on a torque command of the motor. The control device is configured to control the first inverter and the second inverter such that directions of phase currents of two phases of the three-phase coil of the motor is a direction from one inverter toward the other inverter of the first inverter and the second inverter, and a direction of a phase current of one phase of the three-phase coil of the motor other than the two phases is opposite to the directions of the phase currents of the two phases.

In the drive device of the present disclosure, the first inverter and the second inverter are controlled such that the directions of the phase currents of the two phases of the three-phase coil of the motor is the direction from one inverter toward the other inverter of the first inverter and the second inverter. In addition, in the drive device of the present disclosure, the first inverter and the second inverter are controlled such that the direction of the phase current of the one phase of the three-phase coil of the motor other than the two phases is opposite to the directions of the phase currents of the two phases. With such control, a circulating current is generated. The circulating current circulates from two phases of the three-phase coil of the motor to the two phases of the three-phase coil of the motor via one inverter of the first inverter and the second inverter, the power line, one phase of the three-phase coil of the motor other than the two phases, and the other inverter of the first inverter and the second inverter. Accordingly, a large amount of current can flow through the motor and the first and second inverters. As a result, the amount of heat generated by the motor and the first and second inverters can be increased.

The drive device of the present disclosure may further include a load device that is attached to at least one of a positive electrode line and a negative electrode line of the power line. Since heat is generated in the load device by the current flowing through the load device, the amount of heat generated can be increased. In addition, by making the direction of the phase current of the one phase of the three-phase coil of the motor other than two phases opposite to the directions of the phase currents of the other two phases, the current flowing through the power line is reduced as compared with a case where the directions of the phase currents of all the phases of the three-phase coil of the motor are made the same. Therefore, in the case where the load device is attached to at least one of the positive electrode line and the negative electrode line of the power line, the load device can be protected as compared with the case where the phase currents of all the phases of the three-phase coil of the motor are set to the same direction. Therefore, the amount of heat generated can be increased and the load device can be protected.

In addition, in the drive device of the present disclosure, the control device may be configured to perform feedback control on the first inverter and the second inverter such that each of the phase currents of the motor is a current based on a requested heat amount requested for temperature increase of the power storage device. In this way, it is possible to more appropriately generate heat by using the motor and the first and second inverters.

Further, in the drive device of the present disclosure, the control device may be configured to set a d-axis current command and a q-axis current command such that a d-axis current flows in the motor based on requested heat amount requested for temperature increase of the power storage device and a zero-phase current as a sum of the respective phase currents of the motor is a current based on the requested heat amount, then set a voltage command of each of the phases based on the d-axis current command and the q-axis current command, and then control the first inverter and the second inverter using the voltage command of each of the phases. In this way, it is possible to more appropriately generate heat by using the motor and the first and second inverters.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic configuration diagram of a battery electric vehicle equipped with a drive device of an embodiment of the present disclosure;

FIG. 2 is a block diagram showing an example of a functional block in the control of the first inverter and the second inverter by the ECU at the time of the low temperature;

FIG. 3 is an explanatory diagram for describing an example of a flow of a current in the battery electric vehicle of the embodiment;

FIG. 4 is an explanatory diagram for describing a relationship between the respective phase currents of the embodiment and a zero-phase current that is a sum of the respective phase currents;

FIG. 5 is a diagram for describing a relationship between the phase currents of the comparative example and the zero-phase current that is a sum of the phase currents; and

FIG. 6 is a block diagram showing an example of a functional block in the control of the first inverter and the second inverter at the time of the low temperature by the ECU of another embodiment.

### DETAILED DESCRIPTION OF EMBODIMENTS

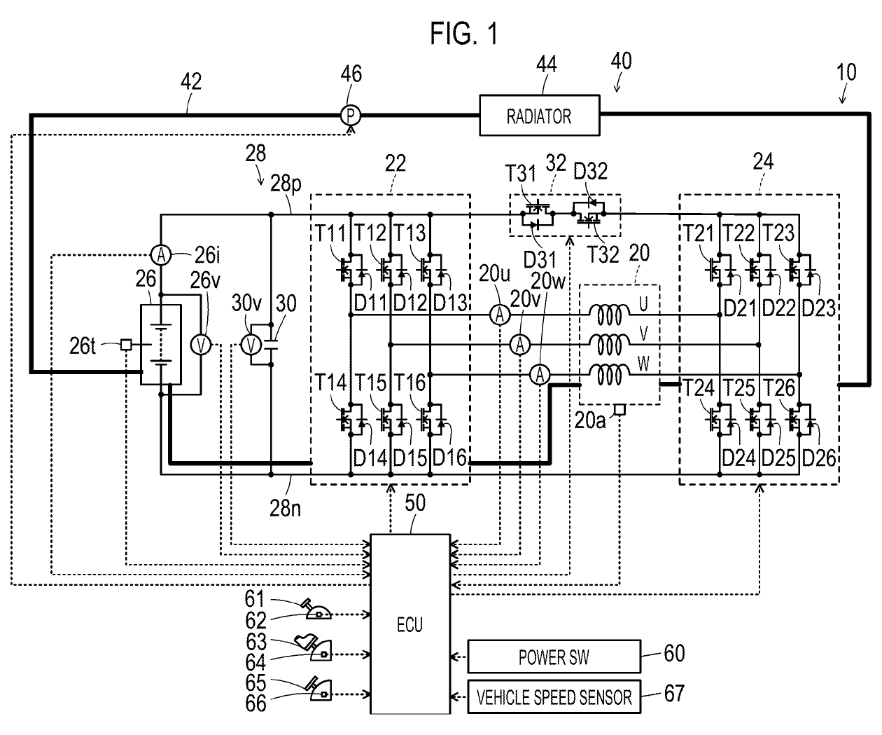

An embodiment for carrying out the present disclosure will be described with reference to the drawings. FIG. 1 is a schematic configuration diagram of a battery electric vehicle 10 equipped with a drive device of an embodiment of the present disclosure. As illustrated, the battery electric vehicle 10 of the embodiment includes a motor 20, first and second inverters 22, 24, a battery 26 as a power storage device, a switching device 32 as a load device, a cooling device 40, and an electronic control unit (hereinafter, referred to as “ECU”) 50 as a control device.

The motor 20 is configured as a three-phase alternating current motor having, for example, a rotor in which a permanent magnet is embedded in a rotor core and a stator in which three-phase (U-phase, V-phase, W-phase) coils are wound around a stator core. The rotor is connected to a drive shaft connected to drive wheels via a differential gear.

The first and second inverters 22, 24 are connected to the power line 28 (positive electrode line 28p and negative electrode line 28n) to which the battery 26 is connected, and are connected to a first end side and a second end side of the three-phase coil of the motor 20, respectively. The first inverter 22 includes six transistors (first switching elements) T11 to T16 as switching elements, and six diodes D11 to D16 connected in parallel to the six transistors T11 to T16, respectively. The transistors T11 to T16 are disposed in pairs such that two transistors are disposed on the source side and the sink side with respect to the positive electrode line 28p and the negative electrode line 28n. Each of connection points of two transistors corresponding to the transistors T11 to T16 is connected to the first end side of the three-phase coil of the motor 20. The second inverter 24 includes six transistors (second switching elements) T21 to T26 and six diodes D21 to D26 as the switching elements, similarly to the first inverter 22. The transistors T21 to T26 are disposed in pairs such that two transistors are disposed on the source side and the sink side with respect to the positive electrode line 28p and the negative electrode line 28n. Each of connection points of two transistors corresponding to the transistors T21 to T26 is connected to the second end side of the three-phase coil of the motor 20. The battery 26 is configured as, for example, a lithium ion secondary battery or a nickel hydrogen secondary battery, and is connected to the power line 28 (positive electrode line 28p and negative electrode line 28n). A capacitor 30 for smoothing is connected to the power line 28. In the embodiment, the battery 26, the capacitor 30, the first inverter 22, and the second inverter 24 are connected in this order to the power line 28.

The switching device 32 is attached to a positive electrode line 28p of the power line 28. The switching device 32 includes two transistors T31, T32 and two diodes D31, D32. The transistors T31, T32 are connected in series to the positive electrode line 28p. The diode D31 is connected in parallel to the transistor T31 such that a direction from the first inverter 22 toward the second inverter 24 is a forward direction. The diode D32 is connected in parallel to the transistor T32 such that a direction from the second inverter 24 toward the first inverter 22 is a forward direction.

The cooling device 40 includes a circulation flow path 42, a radiator 44, and an electric pump 46. The circulation flow path 42 is configured as a flow path for circulating a cooling medium, such as coolant, in this order through the battery 26, the first inverter 22, the motor 20, the second inverter 24, and the radiator 44. The electric pump 46 circulates the cooling medium in the circulation flow path 42. The circulation flow path 42 may be configured as a flow path for circulating the cooling medium through the second inverter 24, the motor 20, the first inverter 22, the battery 26, and the radiator 44 in this order.

The ECU 50 includes a microcomputer having a CPU, a ROM, a RAM, a flash memory, an input/output port, and a communication port, or various drive circuits and various logic ICs. The ECU 50 receives signals from various sensors. As the input signal, for example, a rotation position θm from a rotation position sensor 20a that detects a rotation position of a rotor of the motor 20, and phase currents Iu, Iv, Iw of the respective phases of the motor 20 from current sensors 22u, 22v, 22w that detect phase currents of the respective phases of the motor 20 are included. In addition, as the input signal, for example, a voltage Vb of the battery 26 from the voltage sensor 26v, a current Ib of the battery 26 from the current sensor 26i, and a temperature Tb of the battery 26 from the temperature sensor 26t are included. In addition, as the input signal, for example, a voltage VH of the capacitor 30 (power line 28) from the voltage sensor 30v, an on/off signal from the power switch 60, and an operation position (shift position SP) of the shift lever 61 from the shift position sensor 62 are included. In addition, as the input signal, for example, an accelerator pedal depression amount (accelerator operation amount Acc) of the accelerator pedal 63 from the accelerator pedal position sensor 64, a brake pedal depression amount (brake pedal position BP) of the brake pedal 65 from the brake pedal position sensor 66, and a vehicle speed V from the vehicle speed sensor 67 are included. The ECU 50 outputs switching control signals from the first and second inverters 22, 24 to the transistors T11 to T16, T21 to T26 and the switching control signals to the transistors T31, T32 of the switching device 32. The ECU 50 calculates the electrical angle θe of the motor 20 or the rotation speed Nm based on the rotation position θm of the rotor of the motor 20, or calculates the electric charge storage ratio SOC of the battery 26 based on the integrated value of the current Ib of the battery 26.

In the battery electric vehicle 10 of the embodiment, the ECU 50 sets the request torque Td* requested for traveling based on the accelerator operation amount Acc and the vehicle speed V. Then, the torque command Tm* of the motor 20 is set such that the motor 20 travels with the set request torque Td*, and the switching control is performed on the transistors T11 to T16, T21 to T26 of the first and second inverters 22, 24 based on the set torque command Tm*.

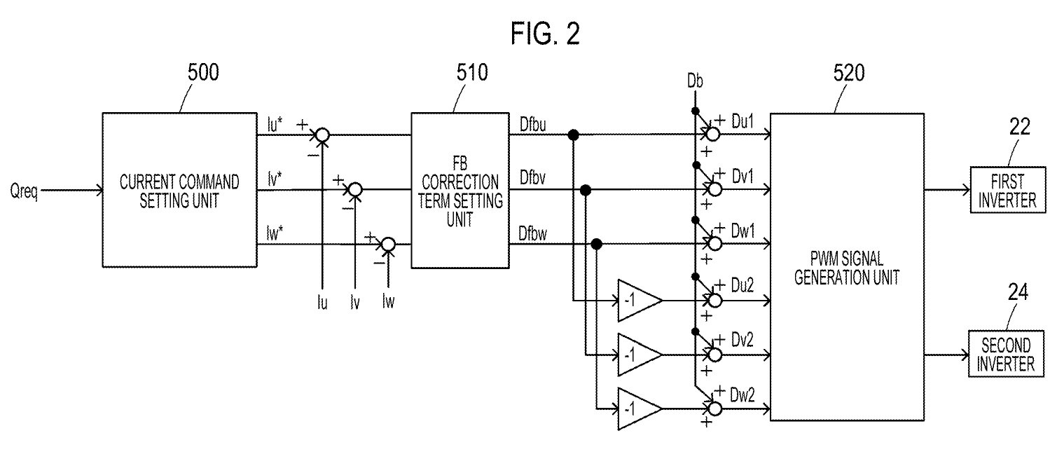

Next, the operation of the battery electric vehicle 10, particularly the control of the first and second inverters 22, 24 at the time of low temperature will be described. FIG. 2 is a block diagram showing an example of a functional block in the control of the first and second inverters 22, 24 by the ECU 50 at the time of the low temperature. As a functional block in FIG. 2, the ECU 50 includes a current command setting unit 500, a feedback (FB) correction term setting unit 510, and a PWM signal generation unit 520. Here, examples of the "low temperature" include a case where the outside air temperature is a temperature equal to or lower than a predetermined temperature (for example, 1°C, 3°C, or 5°C) or a case where the battery 26 is a low temperature at which the battery 26 cannot exhibit its function. It is assumed that the transistors T31, T32 of the switching device 32 are turned on and the battery electric vehicle 10 is stopped.

The current command setting unit 500 sets the current commands Iu*, Iv*, Iw* of the motor 20 based on the requested heat amount Qreq requested for the temperature increase of the battery 26, and outputs the set current commands Iu*, Iv*, Iw*. The ECU 50 determines a relationship between a difference between the current temperature Tb of the battery 26 from the temperature sensor 26t and a lower limit temperature of the temperature range in which the battery 26 can exhibit the performance, and the requested heat amount Qreq in advance by an experiment, analysis, machine learning, or the like, and stores the relationship in the ROM. The requested heat amount Qreq is set from the relationship and the difference between the temperature Tb of the battery 26 from the temperature sensor 26t and the lower limit temperature of the temperature range in which the battery 26 can exhibit the performance. The current command setting unit 500 is configured to set the current values of the current commands Iu*, Iv*, Iw* to be the same, and set the direction of the current for the current commands Iv*, Iw* to be the direction from the second inverter 24 toward the first inverter 22, and set the direction of the current for the current command Iu* to be the direction from the first inverter 22 toward the second inverter 24. The current values of the current commands Iu*, Iv*, Iw* are set to be larger when the requested heat amount Qreq is larger than when the requested heat amount Qreq is smaller, within a range not exceeding the maximum current Immax allowed for the motor 20 and the maximum current Iinvmax allowed for the first and second inverters 22, 24.

The FB correction term setting unit 510 inputs a difference between the current command Iu*, Iv*, Iw* and the phase currents Iu, Iv, Iw of the motor 20 in each phase from the current sensors 22u, 22v, 22w. The FB correction term setting unit 510 sets feedback correction terms Dfbu, Dfbv, Dfbw of the duty command D* for canceling the difference between the current commands Iu*, Iv*, Iw* and the phase currents Iu, Iv, Iw, and outputs the set feedback correction terms Dfbu, Dfbv, Dfbw. Here, the duty command D* is a ratio of an on-time of each transistor in one cycle (sum of the on-time and the off-time of each transistor).

The PWM signal generation unit 520 inputs the duty factor commands Du1*, Dv1*, Dw1* of the first inverter 22 to which the feedback correction terms Dfbu, Dfbv, Dfbw are added to the predetermined basic value Db of the duty factor, and the duty factor commands Du2*, Dv2*, Dw2* of the second inverter 24 to which a value obtained by multiplying a value of −1 to the feedback correction terms Dfbu, Dfbv, Dfbw is added to the basic value Db (for example, 50%). The PWM signal generation unit 520 generates the PWM signals for switching the transistors T11 to T16, T21 to T26 of the first and second inverters 22, 24 by comparing the duty factor commands Du1*, Dv1*, Dw1*, Du2*, Dv2*, Dw2* with the triangular wave (carrier wave). Then, the PWM signal generation unit 520 outputs the generated PWM signal to the first and second inverters 22, 24 to perform the switching control on the transistors T11 to T16, T21 to T26 of the first and second inverters 22, 24. With such control, the phase currents Iu, Iv, and Iw have the same current values as each other, and the first and second inverters 22, 24 are subjected to feedback control such that the phase current Iu is in a direction different from the phase currents Iv, Iw.

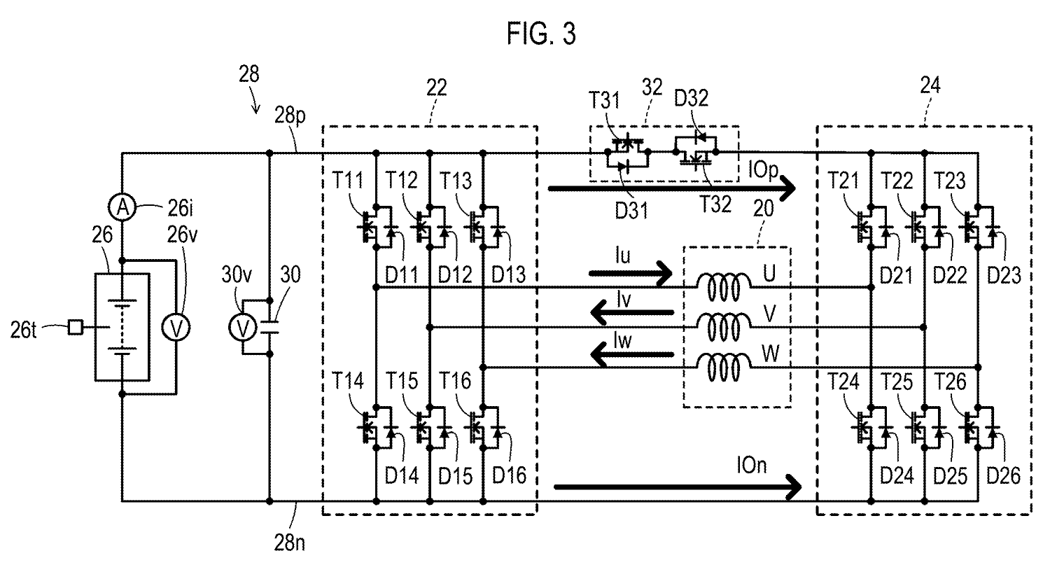

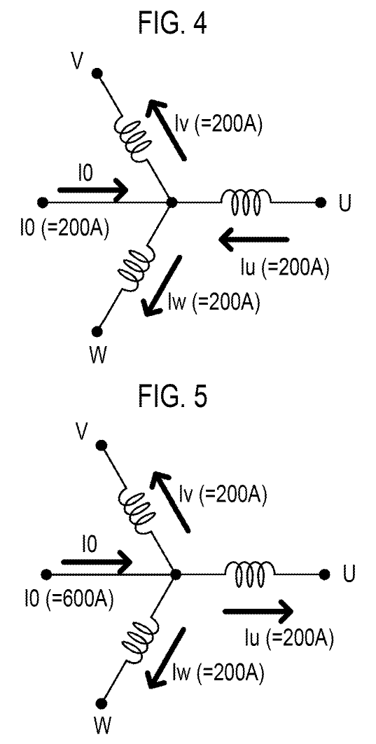

FIG. 3 is an explanatory diagram for describing an example of a flow of a current in the battery electric vehicle 10 of the embodiment. FIG. 4 is a descriptive view for describing a relationship between the phase currents Iu, Iv, Iw of the embodiment and a zero-phase current I0 (= Iu + Iv + Iw) that is a sum of the phase currents Iu, Iv, Iw. FIG. 5 is a diagram for describing a relationship between the phase currents Iu, Iv, Iw of the comparative example and a zero-phase current I0 (= Iu + Iv + Iw) that is a sum of the phase currents Iu, Iv, Iw. In the comparative example, the directions and the current values of the phase currents Iu, Iv, and Iw are set to be the same. In FIGS. 3, 4, and 5, thick arrows indicate the direction of the current.

In the battery electric vehicle 10 of the embodiment, the phase currents Iu, Iv, Iw of the respective phases of the motor 20 have the same current value. In addition, in the battery electric vehicle 10 of the embodiment, the first and second inverters 22, 24 are controlled such that the phase currents Iv, Iw flow in directions from the second inverter 24 toward the first inverter 22, and the phase current Iu flows in a direction from the first inverter 22 toward the second inverter 24. With such control, as shown in FIG. 3, the current circulates from the V-phase and the W-phase of the motor 20 to the V-phase and the W-phase via the first inverter 22 and the positive electrode line 28p and the negative electrode line 28n of the power line 28, and the U-phase and the second inverter 24. Therefore, as shown in FIG. 4, in a case where the phase currents Iu, Iv, Iw are each 200 A, the zero-phase current I0 is 200 A. The phase currents Iu, Iv, and Iw can be increased according to the requested heat amount Qreq as long as the phase currents Iu, Iv, and Iw do not exceed the maximum current Immax allowed for the motor 20 and the maximum current Iinvmax allowed for the first and second inverters 22, 24. Therefore, the amount of heat generated by the motor 20 and the first and second inverters 22, 24 and the switching device 32 can be increased. As a result, the temperature of the cooling medium of the cooling device 40 can be increased to promote the temperature increase of the battery 26. As a result, the deterioration of the battery 26 due to the low temperature can be more appropriately suppressed.

Incidentally, in the comparative example, the first and second inverters 22, 24 are controlled such that the phase currents Iu, Iv, Iw of each phase of the motor 20 flow in a direction from the first inverter 22 toward the second inverter 24 and have the same current value. With such control, the current is divided from each phase of the motor 20 to the positive electrode line 28p and the negative electrode line 28n of the power line 28 via the second inverter 24, and circulates to each phase via the first inverter 22. Therefore, as shown in FIG. 5, in a case where the phase currents Iu, Iv, Iw are each 200 A, the zero-phase current I0 is 600 A. In the embodiment, the direction of one of the phase currents Iu, Iv, Iw of the motor 20 is set to be opposite to the directions of the other phase currents, whereby the zero-phase current I0 can be reduced, and the heat generation of the switching device 32 can be suppressed. As a result, the protection of the switching device 32 can be achieved.

In the battery electric vehicle 10 equipped with the drive device of the embodiment described above, the first and second inverters 22, 24 are controlled such that the direction of the phase currents Iv, Iw of the two phases of the V-phase, W-phase among the three-phase coil of the motor 20 is directed from the second inverter 24 toward the first inverter 22, and the direction of the phase current Iu of the U-phase is opposite to the directions of the V-phase and the W-phase. As a result, the amount of heat generated can be increased more.

Further, since the switching device 32 is provided on the positive electrode line 28p of the power line 28, the amount of heat generated can be further increased, and the switching device 32 can be protected.

Further, since the first and second inverters 22, 24 are subjected to feedback control such that each phase current of the motor 20 is a current based on the requested heat amount Qreq, it is possible to more appropriately generate heat by using the motor and the first and second inverters 22, 24.

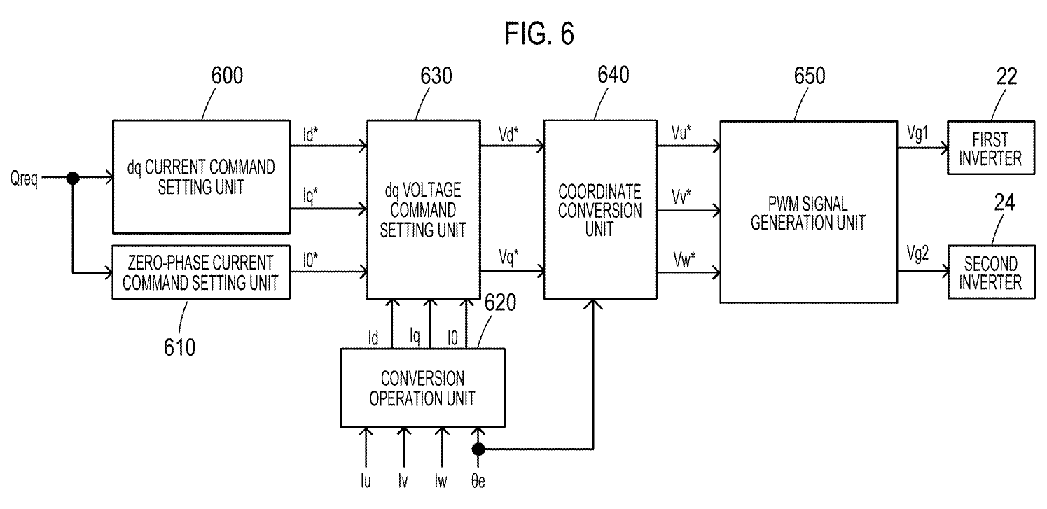

In the above-described embodiment, the first and second inverters 22, 24 perform the feedback control such that the phase currents Iu, Iv, Iw of each phase of the motor 20 become the currents based on the requested heat amount Qreq. However, as in another embodiment described below, the d-axis and q-axis current commands Id*, Iq* may be set such that the d-axis current flows to the motor 20 and the zero-phase current I0 becomes the current based on the requested heat amount Qreq, based on the requested heat amount Qreq. Then, the voltage commands Vu*, Vv*, and Vw of each phase are set based on the current commands Id*, Iq*, and the first and second inverters 22, 24 may be controlled by using the voltage commands Vu*, Vv*, Vw of each phase. FIG. 6 is a block diagram showing an example of a functional block in the control of the first and second inverters 22, 24 at the time of the low temperature by the ECU 50 of another embodiment. As a functional block of FIG. 6, the ECU 50 includes a dq current command setting unit 600, a zero-phase current command setting unit 610, a conversion operation unit 620, a dq voltage command setting unit 630, a coordinate conversion unit 640, and a PWM signal generation unit 650. Here, examples of the "low temperature" include a case where the outside air temperature is a temperature equal to or lower than a predetermined temperature (for example, 1°C, 3°C, or 5°C) or a case where the battery 26 is a low temperature at which the battery 26 cannot exhibit its function. It is assumed that the transistors T31, T32 of the switching device 32 are turned on and the battery electric vehicle 10 is stopped.

The dq current command setting unit 600 sets the d-axis and q-axis current commands Id*, Iq* such that the d-axis current flows to the motor 20 based on the above-described requested heat amount Qreq, and outputs the set current commands Id*, Iq* to the dq voltage command setting unit 630.

The zero-phase current command setting unit 610 sets the current command I0* of the zero-phase current I0 based on the above-described requested heat amount Qreq, and outputs the set current command I0* to the dq voltage command setting unit 630. The zero-phase current command setting unit 610 sets the current command I0* to be larger when the requested heat amount Qreq is larger than when the requested heat amount Qreq is smaller.

The conversion operation unit 620 performs a coordinate conversion of the phase currents Iu, Iv, and Iw of each phase of the motor 20 into the d-axis current Id and the q-axis current Iq by using the electrical angle θe of the motor 20 (three-phase to two-phase conversion). At the same time, the conversion operation unit 620 calculates a zero-phase current I0 (= Iu + Iv + Iw) that is the sum of the phase currents Iu, Iv, Iw, and outputs the currents Id, Iq and the zero-phase current I0 to the dq voltage command setting unit 630.

The dq voltage command setting unit 630 calculates the d-axis and q-axis voltage commands Vd*, Vq* by current feedback control such that the difference between the d-axis and q-axis current commands Id*, Iq* and the currents Id, Iq is canceled and the difference between the current command I0* and the zero-phase current I0 is canceled. The dq voltage command setting unit 630 outputs the calculated voltage commands Vd*, Vq* to the coordinate conversion unit 640.

The coordinate conversion unit 640 performs a coordinate conversion (two-phase to three-phase conversion) of the d-axis and q-axis voltage commands Vd*, Vq* by using the electrical angle θe of the motor 20 to the voltage commands Vu*, Vv*, Vw* of each phase. The coordinate conversion unit 640 outputs the obtained voltage commands Vu*, Vv*, Vw* of each phase to the PWM signal generation unit 650.

The PWM signal generation unit 650 generates the PWM signals of the transistors T11 to T16, T21 to T26 of the first and second inverters 22, 24 by comparison between the voltage commands Vu*, Vv*, Vw* of each phase and the carrier wave voltage (triangle wave voltage), and performs the switching control on the transistors T11 to T16, T21 to T26.

With such control, the current of the motor 20 can be made the same as the current illustrated in FIG. 3, and the amount of heat generated can be increased. As a result, the deterioration of the battery 26 due to the low temperature can be more appropriately suppressed.

In the above-described embodiment, the first and second inverters 22, 24 are subjected to feedback control such that the phase currents Iu, Iv, Iw of the motor 20 become the currents based on the requested heat amount Qreq requested for the temperature increase of the battery 26. However, the duty commands Du1*, Dv1*, Dw1*, Du2*, Dv2*, Dw2* of the first and second inverters 22, 24 may be set based on the requested heat amount Qreq, and the PWM signals for switching the transistors T11 to T16, T21 to T26 of the first and second inverters 22, 24 by comparison with the set duty commands Du1*, Dv1*, Dw1*, Du2*, Dv2*, Dw2* with the triangular wave (carrier wave) may be generated, and the first and second inverters 22, 24 may be feedforward controlled by the generated PWM signals.

In the above-described embodiment, the directions of the currents of the current commands Iv*, Iw* among the current commands Iu*, Iv*, Iw* are set to be the directions from the second inverter 24 toward the first inverter 22. In addition, the current command Iu* among the current commands Iu*, Iv*, Iw* is set such that the direction of the current is a direction from the first inverter 22 toward the second inverter 24. However, the current commands Iu*, Iv*, Iw* may be the current commands Iu*, Iv*, Iw* in which the directions of two of the current commands are opposite to the directions of the other one of the current commands Iu*, Iv*, Iw*. For example, the direction of the current for the current commands Iu*, Iw* among the current commands Iu*, Iv*, Iw* may be set to be the direction from the second inverter 24 toward the first inverter 22. In addition, the current command Iv* may be set such that the direction of the current is from the first inverter 22 toward the second inverter 24.

In the above-described embodiment, the switching device 32 is provided on the positive electrode line 28p of the power line 28. However, the switching device 32 may be provided in the negative electrode line 28n of the power line 28, the switching device 32 may be provided in each of the positive electrode line 28p and the negative electrode line 28n of the power line 28, or the switching device 32 may not be provided.

In the above-described embodiment, the form of the drive device mounted on the battery electric vehicle 10 including the motor 20 has been described, but the present disclosure is not limited thereto. For example, the drive device may be mounted on a hybrid electric vehicle including an engine in addition to the motor, or may be mounted on a fuel cell electric vehicle including a fuel cell in addition to the motor. The drive device may be mounted on a moving body other than the vehicle, a non-moving construction facility, or the like.

The correspondence between the main elements of the embodiment and the main elements of the disclosure described in the column of the means for solving the problems will be described. In the embodiment, the battery 26 corresponds to the “power storage device”, the motor 20 corresponds to the “motor”, the first and second inverters 22, 24 correspond to the “first and second inverters”, the cooling device 40 corresponds to the “cooling device”, and the ECU 50 corresponds to the “control device”.

As for the correspondence between the main elements of the example and the main elements of the disclosure described in the section of means for solving problems, since the example is an example for specifically describing a mode to carry out the disclosure described in the section of summary of the disclosure, the elements of the disclosure described in the section of summary of the disclosure are not limited to the embodiment. That is, the interpretation of the disclosure described in the column of the means for solving the problem should be made based on the description in the column, and the embodiment is merely a specific example of the disclosure described in the column of the means for solving the problem.

Although the embodiment for implementing the present disclosure has been described with reference to the embodiment, the present disclosure is not limited to the embodiment, and can be implemented in various forms within the scope of the spirit of the present disclosure.

The present disclosure can be used in a manufacturing industry of a drive device or the like.

What is claimed is:

1. A drive device comprising:
a power storage device;
a motor including a three-phase coil;
a first inverter that is connected to a power line to which the power storage device is connected and is also connected to a first end side of the three-phase coil, the first inverter including a plurality of first switching elements;
a second inverter that is connected to the power line and is also connected to a second end side of the three-phase coil, the second inverter including a plurality of second switching elements;
a cooling device configured to cool the power storage device, the motor, the first inverter, and the second inverter using a cooling medium; and
a control device configured to control the first inverter and the second inverter based on a torque command of the motor, wherein the control device is configured to control the first inverter and the second inverter such that directions of phase currents of two phases of the three-phase coil of the motor is a direction from one inverter toward the other inverter of the first inverter and the second inverter, and a direction of a phase current of one phase of the three-phase coil of the motor other than the two phases is opposite to the directions of the phase currents of the two phases.

2. The drive device according to claim 1, further comprising a load device that is attached to at least one of a positive electrode line and a negative electrode line of the power line.

3. The drive device according to claim 1, wherein the control device is configured to perform feedback control on the first inverter and the second inverter such that each of the phase currents of the motor is a current based on a requested heat amount requested for temperature increase of the power storage device.

4. The drive device according to claim 1, wherein the control device is configured to set a d-axis current command and a q-axis current command such that a d-axis current flows in the motor based on requested heat amount requested for temperature increase of the power storage device and a zero-phase current as a sum of the respective phase currents of the motor is a current based on the requested heat amount, then set a voltage command of each of the phases based on the d-axis current command and the q-axis current command, and then control the first inverter and the second inverter using the voltage command of each of the phases.
